(19) United States
(12) Patent Application Publication
(10) Pub. No.: US 2021/0115256 A1
(43) Pub. Date: Apr. 22, 2021

(54) FLUXING AGENTS FOR HOT SURFACE DRESSINGS

(71) Applicant: RHODIA OPERATIONS, PARIS (FR)

(72) Inventors: Arnaud BOURDETTE, CHELLES (FR); Frédéric DELFOSSE, PESSAC (FR); Marie-Pierre LABEAU, SEVRES (FR); Thomas LEBARBE, AUDENGE (FR); Hélène MARTIN, CHATILLON (FR); Simon ROUSSEAU, TALENCE (FR); Marie-Laure PIERRE, VILLENAVE D'ORNON (FR)

(73) Assignee: RHODIA OPERATIONS, PARIS (FR)

(21) Appl. No.: 16/608,737

(22) PCT Filed: Apr. 27, 2018
(86) PCT No.: PCT/EP2018/060856

§ 371 Date: Oct. 25, 2019

(30) Foreign Application Priority Data
Apr. 27, 2017 (FR) 1753698

(51) Int. Cl. C08L 95/00; E01C 7/35

(52) U.S. Cl. CPC C08L 95/005; C08K 5/11; E01C 7/351

(57) ABSTRACT

The invention relates to the use, as fluxing agent for the production of a hot surface dressing, of an additive for hydrocarbon binder including at least one compound having the formula CH₃—X—R—Y—R²
where:
   R² is a C₁-C₁₁ chain of alkyl type, advantageously methyl;
   —X— and —Y— are each an ester or amide group with R′═H or C₁-C₄ alkyl; and
   —R— is a C₁-C₁₀ divalent hydrocarbon chain, optionally interrupted by one or more oxygen atoms;
and where the STV pseudo-viscosity measured for said hydrocarbon binder to which has been added 10% by weight of said additive is below 500 seconds.

The present invention pertains to the field of bituminous products which can be used for the production of road surfacings, and more specifically to surface dressing type road surfacings. More specifically, the invention relates to compounds which prove to be well suited as fluxing agents of the hydrocarbon binder during the preparation of hot surface dressings.

Road surfacings of “surface dressing” type constitute a particular family of so-called “bituminous” products, which can be used among other things for road applications, which contain mineral particles (also designated “aggregates”) made integral with each other by a hydrocarbon binder, which may notably be a bitumen, hence the generic product term “bituminous” used in the wide sense, including when the binder is not a bitumen.

The making integral of particles in so-called “bituminous” products is typically obtained by “drowning” the particles in the hydrocarbon binder, whereby what is called a bituminous mix is obtained. In the surface dressings of which it is question in the present description, the making integral is obtained by a less intimate bringing into contact of the mineral particles and the binder. In the sense of the present description, the expression “surface dressing” is taken as the commonly accepted meaning in the field of road surfacings, namely that it designates a bituminous product including at least one course formed by (i) a first stratum including a hydrocarbon binder (often with additives such as polymers or fluxing agents), on which is deposited (ii) a second stratum including solid mineral particles (aggregates). This course with two strata is typically a surface course, with the stratum of aggregates intended to be in contact with traffic. In certain particular cases, a surface of surface dressing type may optionally be covered, for example, by a new surface dressing course. The notion of “surface” dressing in the sense of the present description is not restricted only to surface courses and also includes surface dressings that are intended to be covered over later.

A surface dressing is typically obtained by producing a hydrocarbon binder course (typically by spraying), then by spreading out on this binder solid mineral particles, in one or more layers. In general, the whole is next compacted.

The present invention focuses more specifically on so-called “hot” surface dressings as opposed to “cold” surface dressings which use a hydrocarbon binder in the form of emulsion and may hence be used at relatively low temperatures. In so-called “hot” surface dressings, the hydrocarbon binder not being in the form of an emulsion, it must be used at a sufficient temperature to enable the application of the course where next will be deposited the aggregates. To do so, in a “hot surface dressing” in the sense of the present description, the hydrocarbon binder is typically applied at a temperature of at least 120° C. and in general below 200° C., in general between 120 and 180° C., notably between 130 and 160° C.

Techniques for producing surface dressings, notably hot techniques, are well known and widely used. They turn out to be useful notably for road maintenance.

A central problem with surface dressings, notably hot surface dressings, is to ensure satisfactory adhesivity between the hydrocarbon binder and the aggregates. The adhesivity must in fact be sufficient to make the aggregates integral on the hydrocarbon binder course, which is particularly critical with surface dressings where the binder does not totally enclose the aggregates, unlike the case of mixes.

A surface dressing consequently necessitates the use of a binder which has to be both:
sufficiently fluid to be able to be applied, notably by spraying; and
enable efficient binding of the aggregates.

The hydrocarbon binders that are used in bituminous products are very viscous products, which, notably when they are not implemented in the form of an emulsion, usually necessitate the use of additives in addition to their heating. Different additives of this type, known as “fluxing agents”, have been proposed in the past, of petroleum, petrochemical, carbochemical or even plant origin, which make it possible, among other things, to reduce the viscosity of hydrocarbon binders.

The fluxing agents added to the hydrocarbon binder in the particular case of a hot surface dressing must, schematically, make it possible to “soften” the binder sufficiently to enable its application, but not too much, nor too little, so as not to penalise next the binding of the aggregates by the binder:
in the case of a too fluid binder course: the aggregates that are deposited are only wetted by the fluidified binder, but they are not retained because the binder is not viscous enough;
conversely, in the case of a not sufficiently fluidified binder course: the particles do not manage to penetrate the binder course and are thus not made sufficiently integral, which leads to unsatisfactory, or even unacceptable, adhesion properties.

The more or less “fluid” character of a hydrocarbon binder may be quantified by what is known as the “STV pseudo-viscosity” of the hydrocarbon binder. This pseudo-viscosity, expressed in seconds, corresponds to the flow time of 50 mL of the hydrocarbon binder considered (which may contain additives such as polymers or fluxing agents) at a temperature of 40° C. through an orifice of 10 mm, measured in the conditions defined in the NF EN 12846-2 Standard (April 2011). Typically, for a hydrocarbon binder used to produce a surface dressing, preferably a binder is used having a STV pseudo-viscosity between 300 seconds (generally too fluid if the STV pseudo-viscosity is lower) and 500 seconds (generally not fluid enough above this value) at the moment of bringing into contact the binder and the aggregates.

Furthermore, the affinity between binder and aggregates in a bituminous product of surface dressing type may be quantified by the possibility of wetting the solid mineral particles by the binder and by the capacity of the binder to retain the aggregates, according to the method for determining binder-aggregate adhesivity by a Vialit cohesion measurement, such as defined in the NF EN 12272-3 Standard (July 2003).

The method for measuring the Vialit cohesion (designated here for reasons of brevity “Vialit test”), is described in detail in the aforesaid standard, in its version of July 2003, to which reference may be made if needs be notably for details of the precise, calibrated conditions to implement to carry out the test. To summarise, this Vialit test consists in:
uniformly applying the hydrocarbon binder to test on a steel plate, at the spraying (spreading) temperature used to carry out the surface dressing; then;
spreading out 100 calibrated chippings corresponding to the mineral particles (aggregates) to test on the binder course obtained, and cylindering; then
turning over the plate thereby prepared on a support with three points and releasing a steel ball onto the plate three times in 10 seconds.

At the end of the Vialit test (namely at the end of the third and final impact of the ball on the turned over plate), the 100 chippings are observed (usually some have fallen from the plate and others have remained stuck thereto), and they are broken down as follows:
fallen chippings which do not have any hydrocarbon binder stain, designated “fallen chipping unstained” in the NF EN 12272-3 Standard.
   “a” designates the number of these fallen and unstained chippings.
fallen chippings which have at least one hydrocarbon binder stain, designated “fallen chippings stained” in the NF EN 12272-3 Standard).
   “b” designates the number of these fallen and stained chippings
chippings which remain stuck to the plate, designated “chippings bonded” in the standard).
   “c” designates the number of these bonded chippings;
The sum a+b+c is thus equal to 100 by definition.

The Inventors consider that a hydrocarbon binder (including or not additives) is satisfactory for producing a surface dressing if, by carrying out the Vialit test at a temperature of 5° C. (+/−1° C.), a number c of stuck chippings greater than or equal to 50 is obtained.

It should be noted in this respect that the NF EN 12272-3 Standard focuses on the number b+c (designated “adhesivity value” in the standard) which reflects in fact above all the wetting capacities of the aggregates by the bitumen. That being said, in practice, the number c of particles which remain bound to the plate is more relevant, in so far as it reflects the holding capacity of the surface in the application conditions.

It should be noted moreover that hydrocarbon binders are generally tested according to the Vialit test with an application temperature of the Vialit test of 5° C. (+/−1° C.) in such a way as to ensure that the tested binder will be useable in the most stringent meteorological conditions. That being said, in practice, unless it is specifically intended for use at extremely low external temperatures, a hydrocarbon binder may prove to be entirely satisfactory even if it does not make it possible to reach a number c greater than or equal to 50 for a Vialit test at 5° C. This is the case if it can make it possible to reach this number of stuck chippings c greater than or equal to 50 for a slightly higher application temperature of the test, for example at 10° C. The application temperature of the Vialit test to which reference is made here, designated hereafter “temperature of the Vialit test”, corresponds to the temperature of the climatic chamber where the Vialit test is carried out, which is to distinguish for example the temperature of the binder, which is higher.

For a given binder and aggregates pair, it is possible in general to define a limit temperature of the Vialit test for which suitable adhesion is obtained between the binder and the aggregates. In the sense of the present description, T₅₀ will define the minimum temperature of the Vialit test for which a number of stuck chippings c is obtained of at least 50 in the conditions defined in the NF EN 12272 Standard. As indicated in the preceding paragraph, in general, for given aggregates, the use of a binder is recommended for which the T₅₀ of the binder-aggregates pair considered is at the most 5° C. That being said, this criterion is quite restrictive and it very often proves to be sufficient that this T₅₀ is less than or equal to 10° C. (or even less than or equal to 15° C.) as a function of the conditions that are envisaged to produce the surface dressings.

In a more general manner, in the particular framework of the present patent application, T_{N} designates, where N is an integer greater than 50 (for example N=60, corresponding to T₆₀), the minimum temperature of the Vialit test for which a number of stuck chippings c greater than or equal to N is obtained in the conditions defined in the NF EN 12272 Standard.

Within the scope of the works that have led to the present invention, the Inventors have established that, for the production of hot surface dressings, it is possible for example (but not necessarily) to use associations of binder and aggregates for which:
the T₅₀ is less than or equal to 15° C., more preferentially less than or equal to 10° C., and ideally below 5° C.;
independently, the T₆₀ is preferably less than or equal to 20° C., more preferentially less than or equal to 15° C., and ideally below 10° C.;
independently, the T₇₀ is preferably less than or equal to 25° C., more preferentially less than or equal to 20° C., and ideally below 15° C., or even at 10° C.

To do so, usually, the binder must contain a fluxing agent.

An aim of the present invention is to supply a method making it possible to modify the properties of hydrocarbon binders, notably in such a way as to lower their T₅₀ in ranges suited to the production of hot surface dressings.

To this end, the present invention proposes the use of new additives as fluxing agents in compositions of hydrocarbon binders.

In the past, different types of fluxing agents have been described, among which may notably be cited fluxing agents of petroleum origin which include:
“petroleum based fluxing agents” (derived from the distillation of crude oil (light fraction(s), with an optional hydrotreatment operation, such as products of Greenflux® 2000 or Greenflux® SD type sold by the Total company; and
“petrochemical fluxing agents”, derived from the distillation of crude oil (light fraction(s), with thermal cracking and/or complementary distillation, such as for example fluxing agents of Adheflux® type sold by VFT France.

These fluxing agents of petroleum origin make it possible to lower the viscosity of hydrocarbon binders punctually because they are volatile products: after their incorporation in the hydrocarbon binder, where they ensure the desired viscosity reduction, they evaporate. Which signifies an advantage, namely that the binder substantially recovers its initial characteristics after evaporation, but also and especially drawbacks: the fluxing agents released have however numerous negative impacts on the environment and on users (harmful and disagreeable vapours; flammability risk, etc.).

Other volatile fluxing agents are fluxing agents of rubber origin, derived from the pyrolysis of coal and at least one distillation operation. They have for their part the major drawback of being recognised carcinogens.

To replace these fluxing agents, fluxing agents of natural non-fossil origin (plant or animal origin) have been proposed, which make it possible to avoid the release of harmful volatile organic compounds. A fluxing agent of natural non-fossil origin is a natural non-fossil oil, one of the derivatives thereof such as fatty acid esters, or a mixture of two or more of these oils and/or oil derivatives. It is possible in particular to cite plant oils such as oils of sunflower, rape, peanut, copra, linen, palm, soya, olive, ricin, maize, gourd, grape seed, jojoba, sesame, walnut, hazelnut, china wood, tall oil, derivatives thereof, as well as mixtures thereof. Most of these oils mainly include at least C₁₆ unsaturated fatty acids. Such fluxing agents are for example described in the applications FR 2 910 477, EP 0 900 822, FR 2 721 043 or FR 2 891 838.

With non-volatile fluxing agents of the type of the aforesaid oils, the increase in consistency of the binder in the final product (after spreading or after coating) does not occur by evaporation, unlike the case of volatile fluxing agents, but rather by cross-linking, typically following radical reactions, the unsaturated fatty chains react in the presence of oxygen in the air. These reactions, which can be catalysed by addition of drying agents such as metal salts, include the formation of peroxide —O—O— bridges on the unsaturated chains. These bridges are unstable and lead to the formation of free radicals which themselves are going to react with other unsaturations of other chains. This technique of cross-linking the fluxing agent thereby applies uniquely to unsaturated compounds. The selection of the fluxing agent is made from the iodine index, which characterises the unsaturation level of a compound and thus its capacity to react by siccativation.

While they have lesser effect on the environment and on the well-being and the health of handlers, non-volatile fluxing agents of natural non-fossil origin are however less satisfactory than fluxing agents of petroleum origin in terms of results. Indeed, the rise in cohesion results are less good. They usually lead to disorders in the event of showers, heat or too heavy traffic, problems of bleeding, assigned notably to poor adhesion of the fluxed hydrocarbon binder on the solid mineral particles.

The present invention proposes implementing particular compounds, which the Inventors have now identified as being: (1) compounds which behave like volatile fluxing agents, interesting in that they make it possible, once incorporated in compositions including a hydrocarbon binder and before their evaporation, to reduce the viscosity of the hydrocarbon binder, but without having the drawbacks of usual volatile fluxing agents; and (2) compounds suited to the preparation of hot surface dressings.

Within the scope of the works that have led to the present invention, the Inventors have identified a family of compounds which turn out to be particularly interesting as volatile fluxing agents generally without negative repercussions in terms of effects on the environment and toxicity for their handlers. It involves the family of compounds having the following generic formula (A):

R¹—X—R—Y—R²

in which:
R¹ and R², identical or different, are C₁-C₁₁ hydrocarbon chains, linear or branched;
each of —X— and —Y—, is a —O—(C═O)—; —(C═O)—O—; —NR′—(C═O)— or (C═O)—NR′— group
   with R′ representing a hydrogen or a C₁-C₄ alkyl radical,
the —R— group is a C₁-C₁₀ divalent hydrocarbon chain, linear or branched, and optionally interrupted by one or more oxygen atoms.

The works of the Inventors have made it possible to demonstrate that compounds of formula R¹—X—R—Y—R² such as defined above are systematically interesting fluxing agents when their R¹ and R² groups, identical or different, include at least two carbon atoms. Typically, in most cases, these fluxing agents with C₂-C₁₁ R¹ and R² groups make it possible to obtain a T₅₀ less than 5° C. or below.

On the other hand, the Inventors have demonstrated within the scope of the works that have led to the present invention that, for other compounds of the family, such interesting results are not obtained, and, in particular, that compounds of formula (A) where R₁═CH₃ (hereafter designated “methylated compounds”) are not all suited as fluxing agents notably for hydrocarbon binders intended for the production of hot surface dressings.

Having said that, the Inventors have discovered an efficient means of identifying, among the compounds of formula (A) where R₁═—CH₃, those which turn out to be suitable for the production of surface dressings. To this end, it turns out that to identify if a methylated compound of formula (A) where R₁═—CH₃ is suited to the production of a hot surface dressing, a very simple test suffices: the methylated compound to test is added at a rate of 10% by weight to the hydrocarbon binder desired to produce the hot surface dressing and the STV pseudo-viscosity of the binder thereby added to is measured. The Inventors have now discovered that if the measured STV pseudo-viscosity is less than or equal to 500 seconds, then the methylated compound proves to be suited to use as fluxing agent for the production of hot surface dressings. Conversely, methylated compounds of formula (A) where R₁═—CH₃ for which an incorporation at a rate of 10% by weight in a hydrocarbon binder leads to a STV pseudo-viscosity above 500 seconds cannot be used for the production of hot surface dressings with the considered binder.

It should be noted that the concentration of 10% by weight is that used for the test. In the hydrocarbon binder used concretely to produce the hot surface dressing according to the invention, the concentration of methylated agent is in general much less.

On this basis, the subject matter of the present invention is the use, as fluxing agent in a hydrocarbon binder used for the production of a hot surface dressing, of an additive for hydrocarbon binder including at least one compound having the formula (I) below:

CH₃—X—R—Y—R² (I)

where:
R² is a C₁-C₁₁, preferably C₁-C_{9,} hydrocarbon chain (typically an alkyl), linear or branched;
each of —X— and —Y—, identical or different, is a —O—(C═O)— group; or a —(C═O)—O— group; or a —NR′—(C═O)— group; or a —(C═O)—NR′— group with R′ representing a hydrogen atom or instead a C₁-C₄ alkyl radical; and
the —R— group is a C₁-C₁₀ divalent hydrocarbon chain, linear or branched, and optionally interrupted by one or more oxygen atoms.
   and where the STV pseudo-viscosity measured for said hydrocarbon binder to which has been added 10% by weight (by weight compared to the weight of hydrocarbon binder) of said additive is below 500 seconds. The pseudo-viscosity to which reference is made here is that such as measured in the conditions defined in the NF EN 12846-2 Standard (April 2011).

The additive used within the scope of the present invention may contain:
either a single compound of formula CH₃—X—R—Y—R² with the R², X, Y and R groups having the above definitions,
or a mixture of several compounds of formula CH₃—X—R—Y—R² with several types of R², X, Y and R groups having the above definitions.

An additive for bitumen according to the invention consists in general uniquely of one or more compounds(s) of formula (I).

The family of compounds of formula (I) to which reference is made here corresponds to the “methylated compounds” described above in the present description. The invention specifically pertains to compounds of formula (I) or mixtures of compounds of formula (I) of this family which further successfully pass the test for measuring the STV pseudo-viscosity.

When an additive including a compound of formula (I) or a mixture of compounds of formula (I) is such that its incorporation at a rate of 10% by weight in the hydrocarbon binder (by weight compared to the weight of hydrocarbon binder) leads to a STV pseudo-viscosity below 500 seconds, the Inventors have now demonstrated that there exists for this compound at least one concentration (and in general an entire range of concentrations), in general well below 10% by weight, at which the additive may be used with success for the production of surface dressings, typically with a T50 less than or equal to 15° C., and usually with a T50 less than or equal to 10° C., or even less than or equal to 5° C. (that is to say for a Vialit test carried out at 5° C.+/−1° C. in the conditions of the standard, in general at least 50 chippings remaining stuck to the plate are obtained). Very often, the temperature T₆₀ remains less than or equal to 20° C. and the temperature T₇₀ less than or equal to 25° C.

According to a particular embodiment, according to the invention an additive is used for which the addition of said additive at a rate of 10% into the hydrocarbon binder leads to a STV pseudo-viscosity (still such as measured in the conditions defined in the aforesaid NF EN 12846-2 Standard), designated here “STV with 10% of additive” is well below 500 seconds, for example less than or equal to 450 seconds. According to a more particular embodiment, an additive is used for which the STV with 10% of additive is less than or equal to 400 seconds, for example less than or equal to 350 seconds.

The concentration range to implement is easy to determine on a case by case basis for a given compound, for example by concentration scanning and by carrying out the Vialit test at these different concentrations. Typically, the additive used according to the invention is introduced at a quantity such that the total concentration of compounds of formula (I) added to the hydrocarbon binder is comprised between 1 and 8%, usually between 2 and 7%, for example between 3 and 6% (typically of the order of 4 to 6%) by weight compared to the weight of hydrocarbon binder.

Generally speaking, the family of compounds of formula (I) targeted here contains compound or mixtures of compounds of formula CH₃—X—R—Y—R² , where the R², —X—, —Y—, and —R— groups have the aforesaid significations.

The compounds of formula (I) advantageously have a molecular weight comprised between 130 g/mol and 290 g/mol, more advantageously comprised between 140 g/mol and 250 g/mol, even more advantageously comprised between 150 g/mol and 200 g/mol.

In the compounds of formula (I), the total number of carbon atoms is preferably comprised between 5 and 12. According to an embodiment, the total number of carbon atoms is greater than or equal to 6. Furthermore, it is preferred in general that the total number of carbon atoms is less than or equal to 11, for example less than or equal to 10. Thus, for example, the total number of carbon atoms may be comprised between 6 and 11, for example between 6 and 8.

The total number of carbon atoms defined in the preceding paragraph is in particular valid when the R, R¹ and R² groups are saturated groups, linear or branched.

The R² group advantageously represents a C₁-C₁₁, typically C₁-C₉, alkyl, aryl, alkylaryl, or arylalkyl group, linear or branched, cyclic or non-cyclic, saturated or unsaturated and usually saturated.

The R² group may notably be a methyl, ethyl, n-propyl, isopropyl, benzyl, phenyl, n-butyl, isobutyl, n-pentyl, isoamyl, cyclohexyl, hexyl, n-hexyl, heptyl, isooctyl, 2-ethylhexyl, 2-propylhexyl group.

Advantageously, (notably for reasons of ease of synthesis) R² is a methyl radical and the compound of formula (I) is then a compound which then has the following formula (Ia):

CH₃—X—R—Y—CH₃ (Ia)

where the —X—, —Y—, and —R— groups have the aforesaid significations.

According to an embodiment, the compound of formula (I) may be a diester of a diacid having the following formula (Ib):

CH₃—O—(C═O)—R—(C═O)—O—R¹ (Ib),

where R and R¹ have the aforesaid significations.

The compound of formula (I) may then be for example a dimethyl diester of formula (Iab):

CH₃—O—C(═O)—R—C(═O)—O—CH₃ (Iab),

where R is such as defined previously.

Alternatively, the compound of formula (I) may be a diester of a diol having the following formula (Ic):

CH₃—C(═O)—O—R—O—(C═O)—R¹ (Ic),

where R and R¹ have the aforesaid significations.

The compound of formula (I) may then notably be a diacetate of formula (Iac):

CH₃-(C═O)—O—R—O—(C═O)—CH₃ (Iac)

where R is such as defined previously.

Among the compounds of formula (I) that successfully pass the test for the measurement of STV pseudo-viscosity and which turn out to be well suited for the preparation of hot surface dressings according to the invention, it is possible notably to cite the following compounds:
Compounds of formula (Iab) selected from dimethyl adipate, dimethyl glutarate, dimethyl succinate, and mixtures thereof.
   A quite particularly suited mixture according to this alternative may for example include, by weight compared to the total weight of the mixture (measurable for example by gas phase chromatography), a mixture of dimethyl adipate (for example 4 to 22% by weight), dimethyl glutarate (for example 55 to 77 ° A, by weight), and dimethyl succinate (for example 12 to 32% by weight).
   It is possible to use as compound (I) according to the first alternative, the solvent sold by Solvay under the denomination Rhodiasolv® RPDE.
   More advantageously, it is possible to use the additive available from Solvay under the trade name INNROAD® BOOST.
Compound of formula (Ia), and notably (Iab), where
   the R group is selected from the following groups:
      the R_{MG} group of formula —CH(CH₃)—CH₂—CH₂—,
      the R_{ES} group of formula —CH(C₂H₅)—CH₂—, and
      mixtures thereof.
—X— and —Y— are advantageously esters,
preferably esters of diacids (—X—═—O—(C═O)—; and —Y—═—(C═O)—O—)
or esters of diols (—X—═—(C═O)—O— and —Y—═—O—(C═O)—).
   According to this second alternative, it is possible to use for example the solvent sold by Solvay under the denomination RHODIASOLV® IRIS.

Conversely, it is possible to cite compounds of formula (I) which turn out not to be suited according to the invention.

As an example, it is possible notably to mention dimethyl malonate of formula CH₃—O—C(═O)—CH₂—C(═O)—O—CH₃ which is illustrated in the examples given hereafter. For this compound, the STV pseudo-viscosity measured at 10% remains above 500 seconds.

Different aspects of the invention and embodiments that can be envisaged of the invention are described in greater detail hereafter.

### Hydrocarbon Binder

In the sense of the present description, “hydrocarbon binder” (also designated in a more concise manner by “binder”) is taken to mean any hydrocarbon compound of fossil or plant origin which can be used for the production of bituminous products, this hydrocarbon binder being able for example to be a bitumen, a plant based binder or a synthetic binder of petroleum origin, and being able, independently of its nature, to be pure or modified, notably by addition of dopes or polymer(s). According to an embodiment, a hydrocarbon binder may contain a mixture of different origins, for example a mixture of binder of plant origin and synthetic binder of petroleum origin.

The binder used according to the present invention may moreover be a soft to hard binder, for example a grade ranging from 35/50 to 160/220, preferably between 50/70 and 160/220 or between 70/100 and 160/220.

According to an interesting embodiment, the binder is a bitumen, pure or modified by polymers. The “polymer” modifying the bitumen to which reference is made here may be selected from natural or synthetic polymers. It is for example a polymer of the family of elastomers, synthetic or natural, and in an indicative and non-limiting manner:
random, multi-sequenced or star-shaped copolymers, of styrene and butadiene or isoprene in all proportions (in particular block copolymers of styrene-butadiene-styrene (SBS), styrene-butadiene (SB, also designated SBR for “styrene-butadiene rubber”), styrene-isoprene-styrene (SIS)) or copolymers of the same chemical family (isoprene, natural rubber, etc.), optionally cross-linked in situ,
copolymers of vinyl acetate and ethylene in all proportions,
copolymers of ethylene and esters of acrylic acid, methacrylic acid or maleic anhydride, copolymers and terpolymers of ethylene and glycidyl methacrylate) and polyolefins.

The polymer modifying the bitumen may be selected from recovered polymers, for example “rubber crumbs” or other rubber based compositions reduced into bits or into powder, for example obtained from used tyres or other polymer-based wastes (cables, packaging, agricultural waste, etc.) or instead any other polymer commonly used for modification of bitumens such as those cited in the Technical Guide by the Permanent International Association of Road Congresses (PIARC) and edited by the Laboratoire Central des Ponts and Chaussées “Use of Modified Bituminous Binders, Special Bitumens and Bitumens with Additives in Road Pavements” (Paris, LCPC, 1999), as well as any mixture in all proportions of these polymers.

### Mineral Particles (Appreciates)

The mineral particles used for the production of a hot surface dressing according to the invention are solid particles which may be selected from all those that can be used for the production of surface dressings, notably those usually used to produce road surfacings of this type.

As an example of mineral particles which can be used according to the invention, it is possible notably to cite natural mineral aggregates (chippings, sand, fines) derived from quarries or gravel pits, slags in particular cinders, schists in particular bauxite or corundum, artificial aggregates of any origin and derived for example from municipal solid waste incineration (MSWI) bottom ash, or optionally recycling, as well as mixtures thereof in all proportions.

Natural mineral aggregates typically include:
elements less than 0.063 mm (filler or fines)
sand of which the elements are comprised between 0.063 mm and 2 mm;
chippings, of which the elements have dimensions
   comprised between 2 mm and 6 mm;
   greater than 6 mm;

The size of mineral aggregates is measured by the tests described in the NF EN 933-2 Standard (version May 1996).

The “mineral particles” used in a surface dressing according to the invention are also designated by the terms “0/D mineral fraction”. This 0/D mineral fraction may be separated into two particle sizes: the 0/D mineral fraction and the d/D mineral fraction.

The finest elements (the 0/D mineral fraction) will be those comprised in the range between 0 and a maximum diameter that can be fixed between 2 and 6 mm (0/2 to 0/6), advantageously between 2 and 4 mm. The other elements (minimum diameter greater than 2, 3, 4, 5 or 6 mm; and around up to 31.5 mm) constitute the d/D mineral fraction.

The invention is illustrated by the examples given hereafter for indicative purposes. In these examples, certain tests are carried out with aggregates subjected to washing and sieving and thus only concern the d/D mineral fraction. The invention is not limited to this embodiment, as shown by the other examples, carried out without washing or sieving.

### EXAMPLES

The Vialit test was carried out at 5° C. (+/−1° C.) such as defined in the aforesaid NF EN 12272-3 Standard, using:
a bitumen (grade 70/100−Supplier: Total)
   Into which has further been introduced one or the other of the following additives, used at different contents according to the test:
INNROAD® BOOST (Solvay); or
RHODIASOLV® IRIS (Solvay)
two types of aggregates, according to the test carried out, namely:
   Diorite (La Meilleraie); or
   Quartzite (Chailloué)

According to the test carried out, the 100 chippings tested are used as such, or instead washed and sieved beforehand to remove fines therefrom.

The results obtained are reported in the Table below where the content of additive is given in percentage by weight compared to the weight of bitumen without additive. A number c of bound particles which remains above 50 in this test at 5° C. is systematically observed.

As a comparison, the same tests were carried out with dimethyl malonate. Although it is a compound of formula (I), it proves to be clearly inefficient (the value of c is virtually zero even on increasing the content up to 7.5%).

TABLE
Vialit test at 5° C.

| | | | | Distribution of | | |
|---|---|---|---|---|---|---|
| | | Aggregates | | chippings at the | | |
| Additive | | | Washed | end of the test | | |
| Nature | Content | Nature | and sieved | a | b | c |
| INNROAD ® | 5% | Diorite | no | 0 | 28 | 72 |
| BOOST | | | yes | 0 | 24 | 76 |
| | | Quartzite | no | 0 | 31 | 69 |
| | | | yes | 1 | 24 | 75 |
| RHODIASOLV | 5% | Diorite | yes | 1 | 30 | 69 |
| IRIS | 6.1% | | no | 0 | 40 | 60 |
| | 6.1% | | yes | 0 | 20 | 80 |
| Dimethyl | 7.5% | Diorite | yes | 0 | 99 | 1 |
| malonate | | | | | | |

Furthermore, the additive INNROAD® BOOST was subjected to the Vialit test at a temperature of 10° C., where it leads to improved results compared to those obtained in the above conditions at 5° C. This improvement may be taken advantage of to maintain substantially the properties by reducing the additive content.

INNROAD® BOOST was for example tested at a content of 4.5% in a bitumen 7/100 by using chippings of diorite and the following Vialit distribution was obtained:
a=1; b=21; c=78
   Which shows that with an additive content of 4.5%, results of the same order are obtained as at 5° C. with 5% (presented in the table above):

1. A method for the production of a hot surface dressing comprising:
spreading out solid particles on a hydrocarbon binder, wherein the hydrocarbon binder comprises an additive for hydrocarbon binder including at least one compound having the formula (I) below:
CH₃—X—R—Y—R² (I)
in which:
R² is a C₁-C₁₁, preferably C₁-C₉, hydrocarbon chain, linear or branched;
each of —X— and —Y—, identical or different, is a —O—(C═O)— group; or a —(C═O)—O— group; or a —NR′—(C═O)— group; or a —(C═O)—NR′— group
with R′ representing a hydrogen atom or instead a C₁-C₄ alkyl radical; and
the —R— group is a C₁-C₁₀ divalent hydrocarbon chain, linear or branched, optionally interrupted by one or more oxygen atoms;
wherein the STV pseudo-viscosity measured for said hydrocarbon binder to which has been added 10% by weight of said additive is below 500 seconds.

2. The method according to claim 1, wherein the STV pseudo-viscosity measured for said hydrocarbon binder to which has been added 10% by weight of said additive is below 450 seconds.

3. The method according to claim 2, wherein the STV pseudo-viscosity measured for said hydrocarbon binder to which has been added 10% by weight of said additive is below 400 seconds, preferably below 350 seconds.

4. The method according to claim 1, where the total concentration of compounds of formula (I) added to the hydrocarbon binder is comprised between 1 and 8%.

5. The method according to claim 1, where the compound of formula (I) is a compound having the following formula (Ia):
CH₃—X—R—Y—CH₃ (Ia)
where the —X—, —Y—, and —R— groups are such as defined in claim 1.

6. The method according to claim 5, where the compound of formula (I) is selected from dimethyl adipate, dimethyl glutarate, dimethyl succinate, and mixtures thereof.

7. The method according to claim 5, where, in the compound of formula (Ia), R is selected from:
the R_{MG} group of formula —CH(CH₃)—CH₂—CH₂—,
the R_{ES} group of formula —CH(C₂H₅)—CH₂—, and
mixtures thereof.
